(19) United States
(12) Patent Application Publication
(10) Pub. No.: US 2008/0206099 A1
(43) Pub. Date: Aug. 28, 2008

(54) MAGNETIC SEPARATOR AND ANALYZER USING THE SAME

(76) Inventors: Yoichi ARUGA, Mito (JP); Hajime Yamazaki, Hitachinaka (JP); Kantaro Suzuki, Mito (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/037,504

(22) Filed: Feb. 26, 2008

(30) Foreign Application Priority Data
Feb. 28, 2007 (JP) 2007-048362

(51) Int. Cl. B01J 19/00; B03C 1/00

(52) U.S. Cl. 422/68.1; 210/222

(57) ABSTRACT

An analyzer which collects magnetic particles for immunological analysis includes a magnetic separator adapted to efficiently separate within a short time a reaction product formed by bonding substances such as an object to be measured and the magnetic particles, and a nonmagnetic component other than the reaction product, from a liquid mixture in a vessel of the magnetic separator To perform the separation, a magnet complex having multiple magnets and magnetic materials stacked in alternate form so that magnetic pole pieces on opposed sides of each magnet are homopolar, is disposed outside the vessel that holds a liquid in which the magnetic particles are suspended.

### BACKGROUND OF THE INVENTION

1. Field of the Invention

The present invention relates generally to magnetic separators that collect magnetic particles suspended in a vessel, and to analyzers that use such a magnetic separator. More particularly, the invention relates to a magnetic separator higher than conventional ones in collection efficiency, and to an analyzer that uses the magnetic separator.

2. Description of the Related Art

Devices that apply a magnetic field to the magnetic particles dispersed in a medium and collect these particles are used during various analytical operations. Hereunder, a related conventional technique will be described taking as an example an immunological analyzer used to detect the existence of antigens and antibodies in a biological sample such as blood, and measure the quantities of detected antigens and antibodies.

Known as a technique for immunological analysis is a method used in an analytical process to cause an antigen-antibody reaction in a vessel between an antibody which bonds a magnetic component onto a measurement object placed in a sample, and a labeled antibody including a label, and then separate a reaction product formed by bonding between the measurement object in the sample, the magnetic component, and the labeled antibody, from a nonmagnetic component via magnetic separation means.

In the above conventional method, the magnetic particles suspended in a solvent placed in the vessel are magnetically attracted to the vessel wall using a magnet or magnet complex disposed outside the vessel, and then the solvent and nonmagnetic particles that have not been attracted to the vessel wall during the attraction time interval are washed away to separate the magnetic particles and the nonmagnetic material from each other. Such a method is termed “Bond/Free separation” (B/F separation).

Known conventional techniques include the one disclosed in JP-A-2005-28201.

JP-A-2005-28201 describes a structure in which, in order to separate a colloidal magnetic material, four magnets are arranged at roughly equal intervals outside a vessel such that magnetic pole pieces of two adjacent magnets are homopolar, such that magnetic pole pieces of two other adjacent magnets are heteropolar, and such that the magnetic pole pieces facing each other are heteropolar, and the adjacent heteropolar magnets are interconnected using a magnetic material disposed at a side opposite to the vessel. JP-A-2004-535591 describes a magnetic separator having another arrangement of magnets. Furthermore, various other schemes for magnet arrangement have been proposed. However, since the relationship between the arrangement of magnets and collection efficiency of suspended magnetic particles is realistically difficult to simulate, all existing proposals concerning the form of magnet arrangement are estimated to be based on experimental knowledge.

### SUMMARY OF THE INVENTION

When the collection of magnetic particles is applied to an immunological analyzing method, the magnetic particles dispersed/suspended in the liquid placed in a vessel are collected, but simply using the magnets that generate a strong magnetic field does not improve collection efficiency. Currently, there is no clear theory on what magnetic field distribution should be set to universally collect the magnetic particles such as those suspended near the vessel wall neighboring the magnets and those suspended near the vessel central portion at the position farthest away from the magnets.

Meanwhile, in immunological analyzing methods, reduction of an analyzing time is required and reduction of a B/F separation time is desired. An object of the present invention is to provide a magnetic separator capable of collecting magnetic particles from a vessel more rapidly than in the conventional technique.

In order to achieve the above object, the present invention has the configuration described below.

That is to say, one aspect of the present invention is a magnetic separator comprising: vessel support means on which to rest a vessel formed to accommodate a liquid sample which contains magnetic particles; and a magnet complex which includes a plurality of layered magnets and layered magnetic materials such that one layered magnetic material is interposed between two layered magnets and such that magnetic pole pieces on opposed sides of the magnets are homopolar, the magnet complex being adapted to be disposed outside the vessel when the vessel is installed on the support means. Another aspect of the present invention is an analyzer comprising the above magnetic separator.

The magnetic particles applied to an immunological analyzing method are globular particles with a diameter of an order of micrometers (μm), and these particles are generally termed “magnetic beads.” It is to be understood, however, that the kinds of particles applicable in the present invention are not limited to magnetic beads and can be magnetized particles of any kind. The vessel is typically a test-tube-like vessel formed from glass, a plastic, or the like, but can be of any shape, only if capable of supporting a liquid sample. “Outside the vessel” is a position in which the magnet complex is desirably contiguous to the vessel so that a strong magnetic field will be applied from the magnetic particles in the vessel, but a clearance from several millimeters to several centimeters can be present between the magnet complex and the vessel. The layered magnets and the layered magnetic materials are plate-shaped members ranging from several millimeters to several centimeters in thickness.

The present invention makes it possible to supply a magnetic separator that adsorbs a reaction product within a short time and efficiently onto an inner wall of a vessel which accommodates a liquid containing magnetic particles. An analyzer using the magnetic separator can reduce a measuring time, compared with an analyzer that uses a conventional magnetic separator.

### BRIEF DESCRIPTION OF THE DRAWINGS

FIG. 1 is a plan view showing a simple configuration of a magnetic separator of the present invention;

FIG. 2A is a cross-sectional view of the magnetic separator along the line II-II shown in FIG. 1;

FIG. 2B is a partial enlarged view corresponding to a part A in FIG. 2A;

FIG. 3 is a diagram showing an embodiment of a magnetic separator which has an actuator for a magnet complex;

FIG. 4A is a plan view showing a simple configuration of a magnetic separator based on a conventional technique;

FIG. 4B is a cross-sectional view of the magnetic separator based on the conventional technique along the line IV-IV shown in FIG. 4A; and

FIG. 5 is a plan view of an automatic immunological analyzer which applies the magnetic separator of the present invention.

### DETAILED DESCRIPTION OF THE PREFERRED EMBODIMENTS

A magnetic separator according to the present invention is effectively used in an automated analyzer. The automated analyzer causes antigen-antibody reactions in a vessel or a tube by mixing a sample, a magnetic component, an antibody that bonds the magnetic component onto a measurement object placed in the sample, and a labeled antibody including a label. On the other hand, the magnetic separator magnetically separates the measurement object within the sample, from a liquid mixture that contains a reaction product formed by bonding between the magnetic component and the label, into the reaction product and a nonmagnetic component that has not been magnetically captured. The sample in the liquid mixture contains impurities that reduce analyzing accuracy. The analyzing accuracy can therefore be improved by separating magnetically the reaction product and the nonmagnetic component containing the impurities, and then after removal of the nonmagnetic component, analyzing the reaction product quantitatively with a detector.

An embodiment of the present invention will be described hereunder assuming a method that uses a stepped cylindrical vessel to cause an antigen-antibody reaction between a sample, a magnetic component, an antibody that bonds onto a measurement object placed in the sample, and an antibody including a label.

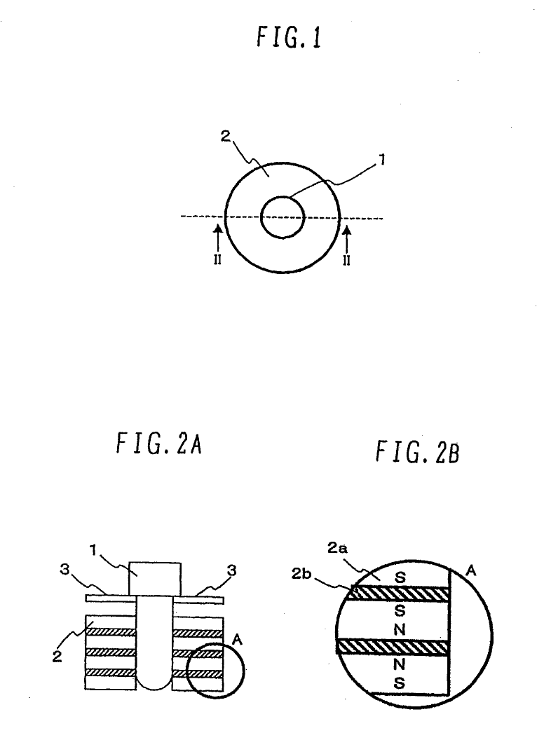

A plan view showing a basic configuration of a magnetic separator according to the present invention is shown in FIG. 1. A cross-sectional view of the magnetic separator along the line II-II in FIG. 1 is shown in FIG. 2A. A partial enlarged view corresponding to a part A in FIG. 2A is shown FIG. 2B. In order to efficiently capture by using magnetism a reaction product present in a liquid mixture created in a vessel 1 and move the reaction product to an inner wall of the vessel 1, the magnetic separator shown in the present embodiment has a magnet complex 2 that shrouds the vessel 1. The magnet complex 2 is constructed with a plurality of magnets 2a and magnetic materials 2b stacked in alternate form, and so that magnetic poles on opposed sides of each magnet are homopolar. In addition, although shrouded by one magnet complex 2 in the present embodiment, the vessel may be shrouded by two or more magnet complexes. The vessel 1 is retained by a retainer 3 holed for a stepped surface to rest thereon.

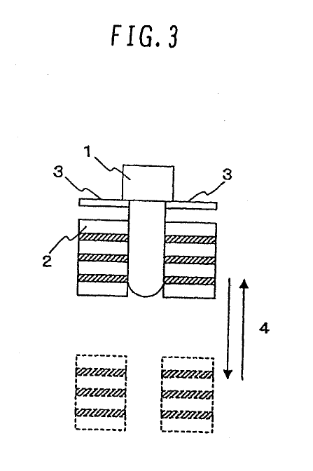

Furthermore, providing an actuator that moves the magnet complex 2 vertically as shown in FIG. 3 makes it possible to apply the magnetic separator more widely by moving the magnet complex 2 vertically with respect to the vessel 1.

For example, when the magnet complex 2 is brought into contact with or close proximity to the vessel 1, the reaction product containing a magnetic material is captured onto the inner wall of the vessel 1. Under this state, an impurity-containing nonmagnetic component that has not been captured onto the inner wall of the vessel 1 can be removed by aspiration with an aspiration nozzle. Pipetting a washing solution with the magnet complex 2 positioned at a sufficient distance from the vessel 1 makes the reaction product easily leave the inner wall of the vessel, diffuses the washing solution over the entire reaction product, and thus allows detaching of impurities adhering to the reaction product which may have not been completely removed during the above aspiration. Next when the magnet complex 2 is brought into contact with or close proximity to the vessel 1 once again, the reaction product containing the magnetic material is captured onto the inner wall of the vessel 1. Additionally, the washing solution that may contain impurities can be removed in substantially the same manner as that mentioned above, that is, by the aspiration with the aspiration nozzle. Repeating this procedure enhances a reaction product washing effect and provides more accurate analytical results. After the washing solution has been pipetted, if contents of the vessel are stirred to such an extent that a bond of the reaction product is not broken, a further improvement in the washing effect is expected. Providing an actuator that moves the magnet complex 2 with respect to the vessel 1, therefore, is very useful particularly in that repetitive washing of the reaction product which contains magnetic particles can be effectively executed.

Comparisons on a magnetic particle collection time and collection efficiency in the present embodiment and on those of an example of a conventional magnetic separator are shown below for confirmation of usefulness of the magnetic separator in the embodiment.

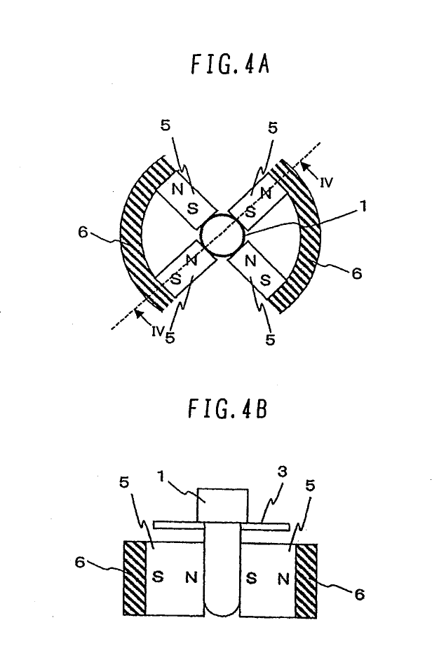

The example of the conventional magnetic separator has had such a configuration as in FIGS. 4A and 4B. More specifically, four magnets 5 are arranged radially around a vessel 1 at equal intervals and oriented towards a central section of the vessel 1 so that magnetic pole pieces of two adjacent magnets are homopolar, magnetic pole pieces of two other magnets, heteropolar, and the magnetic pole pieces facing each other are heteropolar, with the adjacent heteropolar magnets being interconnected using a ferromagnetic material 6 disposed at a side opposite to the vessel. The present embodiment has such a configuration as in FIGS. 1 and 2, with four magnets 2a and three magnetic materials stacked in an alternate fashion to form such a ring-shaped magnet complex 2 around a vessel 1 that opposed sides of each of the magnets are homopolar. Next, dimensions of constituent elements are shown below. In the present embodiment, the vessel 1 of a round-bottomed cylindrical shape has a 6-mm outside diameter and a 26-mm height, the ring-shaped magnet complex 2 has a 7.5-mm height, a 6-mm inside diameter, and a 15-mm outside diameter, each magnet 2a has a 1.5-mm thickness, and each magnetic material 2b has a 0.5-mm thickness. In the example of the conventional magnetic separator of FIGS. 4A and 4B, each magnet 5 is 7.5 mm high, 5 mm wide, and 7 mm deep (a side that measures 7.5 mm by 5 mm is in contact with the vessel), each magnetic material 6 is 7.5 mm high and 4 mm thick, and an inner surface of a magnet complex 2, the magnet 5, and the vessel 1 are in contact with one another. The vessel 1 used in the present embodiment is formed from polypropylene, the magnet 2a and the magnet 5 are formed of a magnet material that contains neodymium (Shin-Etsu Chemical's product code N45 or equivalent), and the magnetic material 2b and the magnetic material 6 are ferromagnetic materials of grade SS400 or equivalent (i.e., rolled steel materials for general structural use, or equivalent). The Multisizer 3, a grain size distribution analyzer manufactured by Beckman Coulter, Inc., is used as a magnetic particles counter, and an MP solution contained in special TSH reagents for the Elecsys, an automatic reagent storage system manufactured by the Roche Diagnostics Corp., is used as a magnetic particle solution. This solution is hereinafter referred to as the MP solution.

Next, the steps of measuring the magnetic particle collection time and the collection efficiency are described below. First, the vessel 1 into which 150 μL of the sufficiently stirred MP solution has been pipetted is installed on a vessel retainer 3. After elapses of 2 seconds, 3 seconds, 5 seconds, and 8 seconds, the MP solution is aspirated from the vessel by means of an aspiration nozzle. Next, 150 μL of diluent Isoton II_pc for the Multisizer 3 is added to a residual solution using a pipettor, and then both solutions are stirred using the pipettor. Additionally, 30 μL of a solution formed by this stirring operation is diluted with 10 mL of diluent Isoton II_pc for the Multisizer 3, and the number of magnetic particles in 500 μL of the diluted solution is measured. The number of magnetic particles in 500 μL of a solution formed by diluting 30 μL of a sufficiently stirred solution with 10 mL of diluent Isoton II_pc for the Multisizer 3 is also measured as a reference. Five-fold such measurements are performed under different collection time conditions independently for each of the above two magnetic separators, that is, the magnetic separator of the present invention, shown in FIGS. 1 and 2, and the conventional magnetic separator shown in FIGS. 4A and 4B. In addition, ratios of average values under various measuring conditions with respect to the number of magnetic particles measured as the reference are calculated as magnetic particle collection ratios.

Table 1 lists magnetic particle collection ratios obtained under collection time conditions of 2 seconds, 3 seconds, 5 seconds, and 8 seconds, in the magnetic separator of the present invention and the conventional magnetic separator.

TABLE 1

Collection time

| | 2 sec | 3 sec | 5 sec | 8 sec |
|---|---|---|---|---|
| Conventional | 78.5% | 92.0% | 98.1% | 98.7% |
| technique | | | | |
| Present | 92.5% | 99.1% | 98.9% | 99.5% |
| invention | | | | |

It has been found that whereas the conventional magnetic separator needs a collection time of 5 seconds to attain a magnetic particle collection ratio of at least 95%, the magnetic separator of the present invention only needs a collection time of 3 seconds to attain an equivalent performance level.

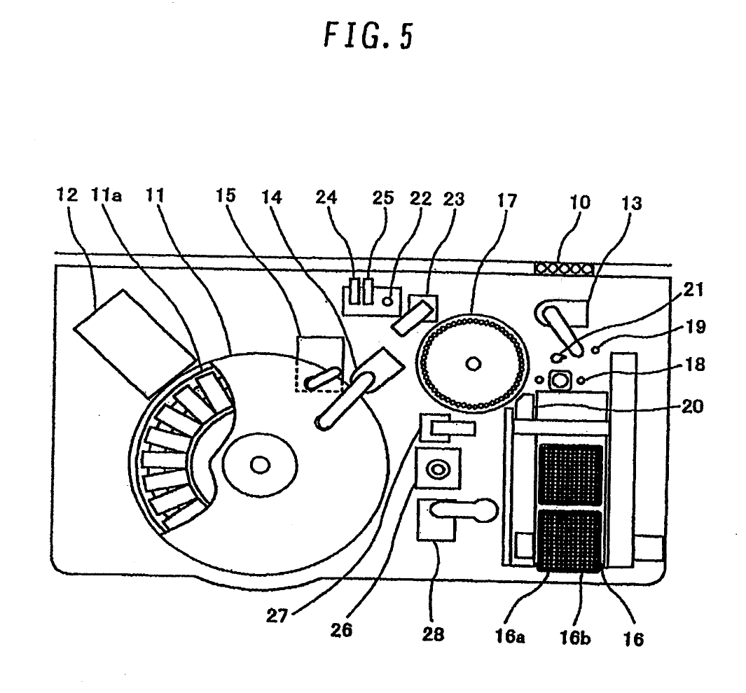

An example of applying the magnetic separator of the present invention to an automatic immunological analyzer is described below. This automatic immunological analyzer with the underside of FIG. 5 as a front section includes constituent elements such as: a sample rack 10 on which to rest samples; a reagent compartment 11 in which to store a capped reagent cassette 11a which contains magnetic particles and a reagent required for an immune reaction; a reagent cassette cap opener/closer 12 that opens and closes the cap of the capped reagent cassette 11a; a sample pipettor 13 that picks and pipettes a sample; a reagent pipettor 14 that picks and pipettes the reagent and magnetic particles from the capped reagent cassette 11a; a magnetic particle mixer 15 that mixes the magnetic particles in the capped reagent cassette 11a; a magazine 16 that contains a vessel 16a used for incubation, and a pipetting tip 16b used to pick and pipette the sample; a temperature-controllable incubator 17 that causes a reaction between the sample and reagent in the vessel 16a; a gripper 20 that transports the vessel 16a to the incubator 17 and a vessel disposal unit 18, and transports the pipetting tip 16b to a temporary storage buffer 19 for pipetting the sample; a tip disposal unit 21 that disposes of the pipetting tip 16b after the tip 16b has been used for pipetting the sample; a gripper 23 that transports the vessel 16a from the incubator 17 to the magnetic separator 22, or vice versa; an impurity aspirator 24 that, after the transport of the vessel 16a to the magnetic separator 22, aspirates a liquid which contains impurities present in the vessel 16a; a washing solution pipettor 25 that pipettes a washing solution into the vessel 16a which has been transported to the magnetic separator 22; a gripper 27 that transports the vessel 16a from the incubator 17 to a detector 26, or vice versa; and a reagent dispenser 28 that dispenses a detection reagent into the vessel 16a which has been transported to the detector 26.

Standard operation is next described below. First, the gripper 20 transports the vessel 16a from the magazine 16 to the incubator 17 and transports the pipetting tip 16b to the buffer 19. The incubator 17 then rotates and the transported vessel 16a moves to a reagent-pipetting position. The reagent pipettor 14 pipettes a reagent from the reagent compartment 11 into the vessel 16a placed on the incubator 17. Once again, the incubator 17 rotates and the vessel 16a moves to the reagent-pipetting position. The tip 16b that has been transported to the buffer 19 is mounted in or on a tip retainer by a vertical movement of the sample pipettor 13, then a sample is picked from the sample rack 10, and the sample is pipetted into the vessel 16a that has moved to the sample-pipetting position. After being used, the pipetting tip 16b is discarded into the tip disposal unit 21 by another vertical movement of the sample pipettor 13. After waiting for a certain time in the incubator 17 for a reaction to occur therein, the vessel 16a in which the pipetting of the sample and the reagent has been completed moves to the reagent-pipetting position by a rotation of the incubator 17, and magnetic particles are picked and pipetted from the reagent compartment 11 by the reagent pipettor 14. After a certain waiting time for a further reaction to occur in the incubator 17, the incubator rotates and the gripper 23 transports the vessel 16a from the incubator to the magnetic separator 22. Aspiration by the impurity aspirator 24 and the pipetting of the washing solution by the washing solution pipettor 25 are repeated on the magnetic separator 22 to separate the magnetic component containing a reaction product present in the vessel 16a, and a nonmagnetic component that contains impurities. Only the magnetic component containing the reaction product is finally left in the vessel 16a, and the vessel 16a is returned to the incubator 17 by the gripper 23. The incubator 17 rotates and after the transport of the vessel 16a to the detector 26 by the gripper 27, the reagent for detection is pipetted into the vessel 16a by the reagent dispenser and detected. The vessel 16a for which the detection has been completed is returned to the incubator 17 by the gripper 27. The incubator 17 rotates, and the vessel 16a is transported to the disposal unit 18 by the gripper 20 and discarded. After this, the above-described sequence is repeated for each subsequent sample.

What is claimed is:

1. A magnetic separator comprising:
vessel support means for supporting a vessel formed to accommodate a liquid sample which contains magnetic particles; and
magnet arrangement means on which, when the vessel is installed on the vessel support means, a magnet complex including a plurality of layered magnets and layered magnetic materials arranged such that one layered magnetic material is interposed between two layered magnets and such that magnetic pole pieces on opposed sides of the magnets with the magnetic material interposed therebetween are homopolar is disposed outside the vessel.

2. The magnetic separator according to claim 1, wherein:
the magnetic material is a ferromagnetic material.

3. The magnetic separator according to claim 1, wherein:
the magnet complex further includes a tubular hole formed for inserting the vessel into the hole, the hole being provided in a direction substantially orthogonal to the layers of the magnets.

4. An automated analyzer comprising:
a magnetic separator according to claim 1;
a pipettor for pipetting a sample into a vessel rested on the magnetic separator; and
means for detecting a label bonded onto a magnetic particle separated inside the vessel.
